(19) United States
(12) Patent Application Publication
(10) Pub. No.: US 2017/0285855 A1
(43) Pub. Date: Oct. 5, 2017

(54) METHOD AND SYSTEM HYBRID STYLUS

(71) Applicant: NVIDIA CORPORATION, Santa Clara, CA (US)

(72) Inventors: Zongyong Chen, Santa Clara, CA (US); Arman Toorians, San Jose, CA (US)

(21) Appl. No.: 15/628,556

(22) Filed: Jun. 20, 2017

Related U.S. Application Data
(63) Continuation-in-part of application No. 14/250,254, filed on Apr. 10, 2014.
(60) Provisional application No. 61/810,578, filed on Apr. 10, 2013.
(60) Provisional application No. 61/810,997, filed on Apr. 11, 2013.

(51) Int. Cl. G06F 3/041; G06F 3/0354; G06F 3/038; G06F 3/044

(52) U.S. Cl. CPC G06F 3/0416; G06F 3/044; G06F 3/03545; G06F 3/0383; G06F 2203/04105

(57) ABSTRACT

Embodiments of the present invention are directed to systems for improved touch screen user-input devices that combine the benefits of active and passive touch screen implementations. According to one or more embodiments of the present invention, a system is provided that includes a user input touch device (such as a stylus) that can be equipped with one or more tips of various sizes and shapes, and a touch screen input surface that is configured to detect each of the various tips. In contrast to prevailing conventional active stylus implementations, this allows touch screen implementations to use styluses with tips that simulate real-world artistic tools that are currently not available in digital arts media. Moreover, data obtained in the input device itself is communicated to the touch screen processor/controller to supplement the input data received in the touch screen device.

### CROSS REFERENCE TO RELATED APPLICATIONS

This application is a Continuation-in-Part of U.S. application Ser. No. 14/250,254, filed Apr. 10, 2014 entitled “Stylus Signaling for Capacitive Touch Screen Panels” to Pedersen et al., which claims benefit of U.S. Provisional Applications No. 61/810,578, filed Apr. 10, 2013 entitled “Methods for Operating a Touch Screen Enabled Device with a Low Cost Stylus” to Huang et al., and U.S. Provisional Application No. 61/810,997, filed Apr. 11, 2013 entitled “Pen Signaling for Capacitive Touch Panels” to Pedersen et al. This application is related to U.S. patent application Ser. No. 14/165,324, filed Jan. 27, 2014 entitled “Stylus Tool with Deformable Tip” to Zerayohannes et al., which is incorporated by reference herein in its entirety.

### FIELD OF THE INVENTION

Embodiments of this present invention are directed toward improving user interactions with touch input devices. More specifically, embodiments of the invention are directed to solutions for an improved user experience with touch input devices by enhancing the sensitivity and accuracy of touch input devices.

### BACKGROUND OF THE INVENTION

In the field of touch screen devices, there exists a need for writing utensils capable of interacting with touch screens to provide more versatile user input. Typically, these writing utensils have been implemented as styluses (or similar touch input devices), which mimic the shape and feel of traditional writing tools such as pens. Historically, these styluses were implemented as “passive” tools that were compatible with the detection scheme employed by the corresponding touch screen, without inherent processing or communication ability.

Resistive touch screens were a popular early touch screen implementation, and are still used in many applications. One type of resistive touch screen involves two layers of electrically-resistive lines of electrodes, placed one above the other and spaced slightly apart. The lines of each layer are parallel with respect to the other lines of the same layer, and perpendicular with the lines of the other layer, thus forming a grid or matrix. When pressed by an object (such as a finger or stylus), the two layers come into contact, a contact point is created that causes a disruption to the voltage levels in the layers. The voltage across the touch screen is measured frequently by an array of sensors beneath the second layer, and any deviations in the voltage resulting from the contact between the layers (as pressed together by the input object) are detected. The point at which the object contacted the top layer is then specifically determined in the second layer (via proximity to the closest sensor) and registered as user input. A second type of resistive touch screen applies a uniform voltage gradient to a top layer. When the two layers are pressed together as a result of a contacting object, the underlying layer measures the voltage as a distance along the top layer, and generates a location coordinate along a first axis from the measurement. The voltage gradient is then applied to the bottom layer to determine the location coordinate along the other axis, and the position of the contact point is determined by combining the coordinate information.

More recently, capacitive sensors have been used increasingly in lieu of traditional resistance-based touch screens, due to their relatively improved sensitivity and accuracy, and reduced size requirements. Even more recently, the detection of multiple touch inputs has been made possible by developments in the underlying touch controllers. Capacitive touch screens operate by maintaining an electrostatic field across the surface of a touch screen using an array of capacitive sensors. When an electrically conductive object (such as a finger or a specialized touch input device) comes into contact with the surface of the screen, the electrostatic field is distorted, resulting in a change in the capacitance at the sensors nearest to the contact point. Mere detection of the input position requires no active components from the input device, and any non-insulated material can be used.

As the technology of capacitive sensors and corresponding software has developed, the resolution (e.g., sensor density) of the touch screens has been able to increase commensurately, thereby also increasing the sensitivity and accuracy of registered touch inputs as well. This improved functionality has led to the rise of touch screens for new endeavors. Whereas in early implementations touch screens were typically limited to registering activation or user actuation of graphical interface elements such as buttons or virtual keyboard keys, advanced touch screen implementations have been extended to be used for handwriting, digital arts and other more advanced user input, particularly with the use of specialized styluses.

Conventional touch-screen implemented digital arts typically use a single, narrow-tipped stylus to perform writing and drawing motions on the touch screen. However, these implementations (referred to as passive styluses) present an issue when the user wants to express a different font or stroke size. One popular alternative to passive styluses that has been developed allows the user to increase the width of an input (such as a stroke) proportionally to correspond to a pressure applied to the stylus, by detecting the pressure in the stylus using a pressure sensor, and communicating the pressure data to the touch screen device. These implementations—with the ability to determine additional user input data and to communicate such data—are known as active styluses. However, while suitable for expressing different stroke or font widths, not only do active styluses require additional sensor, circuit, and communication components to detect and communicate such data, the very act of applying pressure proportionally to increase input thickness is not intuitive in that it does not typically correspond to how artists use most real-world tools outside the field of digital arts, and as such can feel unnatural or counter-intuitive.

### SUMMARY OF THE INVENTION

This Summary is provided to introduce a selection of concepts in a simplified form that are further described below in the Detailed Description. This Summary is not intended to identify key features or essential features of the invention, nor is it intended to be used to limit the scope of the invention.

Embodiments of the present invention are directed to techniques for improved touch screen user-input devices that combine the benefits of active and passive touch screen implementations. According to one or more embodiments of the present invention, a system is provided that includes a user input touch device (such as a stylus) that can be equipped with one or more tips of various sizes and shapes, and a touch screen input surface that is configured to detect each of the various tips. In contrast to prevailing conventional active stylus implementations, this allows touch screen implementations to use styluses with tips that simulate real-world artistic tools that are currently not available in digital arts media. Moreover, data detected (or pre-determined) in the touch input device itself is communicated to the touch screen processor/controller to supplement the input data received in the touch screen device.

In one or more embodiments, the user input touch device is equipped with a circuit that is configured to wirelessly communicate data corresponding to characteristics of the device. According to such embodiments, a computing device paired to the user input touch device is also included, which comprises a wireless receiver configured to receive the data, an input surface or touch screen implemented using a plurality of capacitive sensors, and a processor configured to implement a touch controller that manages and coordinates the operation of the capacitive sensors. The touch controller is configured to, for example, detect a position of the user input touch device and the shape of the tip of the user input touch device based on one or more contact points between the touch device and the input surface. According to one or more embodiments, the data transmitted from the input touch device is used to supplement touch-detection data determined with the capacitive sensors and processed by the touch controller to improve accuracy and precision of both the input and the type of input received.

According to another embodiment, a method is provided for generating touch input data using a hybrid stylus and a capacitive touch screen. In one or more embodiments, this method includes detecting a touch input generated by a touch input device in a touch screen; generating, in a touch controller of a touch screen device comprising a plurality of capacitive sensors, a data corresponding to a position and tip shape of a user input touch device; receiving, from the user input touch device over a wireless communication connection, data corresponding to a plurality of characteristics of the user input touch device; supplementing the generated signal with the data corresponding to a plurality of characteristics of the user input touch device; and calculating touch input from the supplemented signal.

According to further embodiments, generating the signal comprising data corresponding to the position and tip shape of a user input touch device may comprise, for example: measuring relative accumulated charges in a plurality of capacitive sensors, determining at least one contact point corresponding to the position of the user input touch device based on the relative accumulated charges, measuring a discharge rate at the at least one contact point, determining a tip shape corresponding to the user input touch device based on the discharge rate, and generating the signal based on the determined position and tip shape corresponding to the user input touch device.

### BRIEF DESCRIPTION OF THE DRAWINGS

The accompanying drawings are incorporated in and form a part of this specification. The drawings illustrate embodiments. Together with the description, the drawings serve to explain the principles of the embodiments:

FIG. 1 depicts a diagram of an exemplary touch input device with a plurality of input interfaces, in accordance with various embodiments of the present invention.

FIG. 2A depicts an exemplary touch input detection in a touch screen device of a touch input device with a first input interface, in accordance with various embodiments of the present invention.

FIG. 2B depicts an exemplary touch input detection in a touch screen device of a touch input device with a second input interface, in accordance with various embodiments of the present invention.

FIG. 2C depicts an exemplary touch input detection in a touch screen device of a touch input device with a third input interface, in accordance with various embodiments of the present invention.

FIG. 2D depicts an exemplary touch input detection in a touch screen device of a touch input device with a fourth input interface, in accordance with various embodiments of the present invention.

FIG. 3 depicts a flowchart of an exemplary process for calculating touch input in a touch screen device, in accordance with various embodiments of the present invention.

FIG. 4 depicts a flowchart of an exemplary process for determining a position and tip shape of a touch input device in a touch screen, in accordance with various embodiments of the present invention.

FIG. 5 depicts an exemplary computing system upon which embodiments of the present invention may be implemented, in accordance with various embodiments of the present invention.

### DETAILED DESCRIPTION

Reference will now be made in detail to the preferred embodiments of the invention, a method and system for a hybrid touch input device, examples of which are illustrated in the accompanying drawings. While the invention will be described in conjunction with the preferred embodiments, it will be understood that they are not intended to be limit to these embodiments. On the contrary, the invention is intended to cover alternatives, modifications and equivalents, which may be included within the spirit and scope as defined by the appended claims.

Furthermore, in the following detailed descriptions of embodiments of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

Some portions of the detailed descriptions that follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “storing,” “creating,” “protecting,” “receiving,” “encrypting,” “decrypting,” “destroying,” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices.

Embodiments of the invention are directed to novel solutions for improved touch input interfaces using hybrid touch input devices.

### Hybrid Touch Input Device

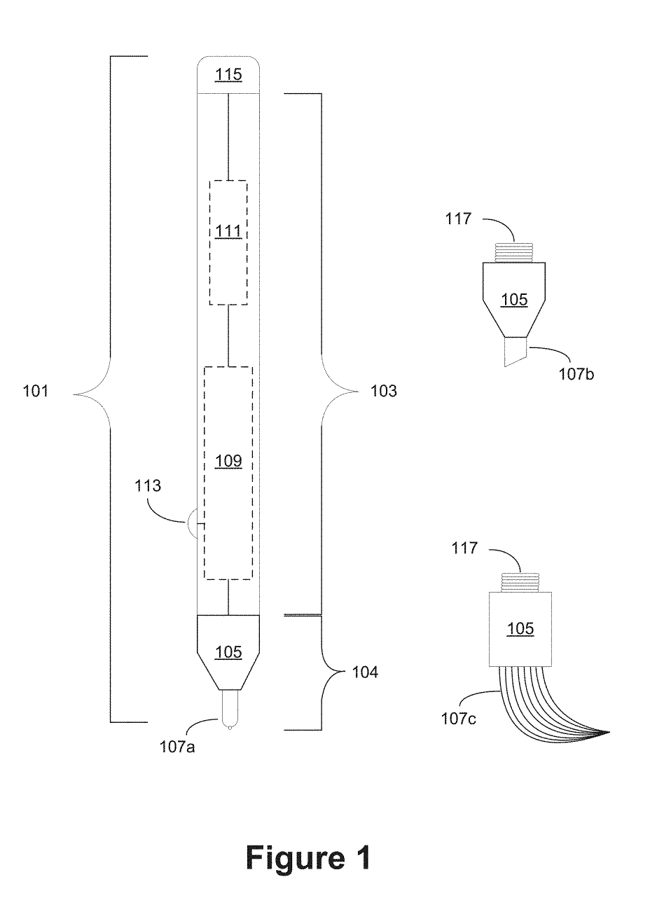

FIG. 1 depicts a diagram of an exemplary touch input device 101 with a plurality of input interfaces, in accordance with various embodiments of the present invention. As depicted in FIG. 1, a touch input device 101 according to one or more embodiments of the present invention may include a body 103, and a tip 104. According to one or more embodiments, the touch input device 101 may be implemented as a stylus, with a relatively thin, bacillar body 103 shaped similarly to a writing utensil such as a pen, pencil, or brush, with roughly the same or analogous dimensions. The body 103 may, in one or more embodiments, be implemented as a hollow or relative hollow shell composed from any number of electrically conductive materials suitable to be comfortably grasped and held. As depicted in FIG. 1, the touch input device 101 includes a tip 104 implemented with a tip base 105 and a nib (107a, 107b, 107c). The tip 104 may also be composed of one or more electrically conductive materials, and is attached at one end of the body 103 at a corresponding end of the tip base 105. Attached on the other end of the tip base 105 is an electrically conductive nib 107a operable to generate touch input in a compatible touch screen (e.g., a capacitive sensing touch screen).

Tips may be equipped with nibs (107a, 107b, 107c) of varying shapes and sizes. In one or more embodiments, the tip 104 (via tip base 105) can be decoupled (removed) from the body 103 and replaced with another tip to suit various purposes. As depicted in FIG. 1, tip 104 may be attached and detached using a grooved (e.g., screw) type mechanism on the end of the tip base 105 opposite of the nib (107a, 107b, 107c). Other attachment means may include clips, magnets, or other mechanisms for fastening the tip base 105 to the body 103. In still further embodiments, tip 104 may be statically coupled to the body 103 with only the particular nib (e.g., 107a, 107b, and 107c) being adjustable and replaceable. For example, nib 107a is depicted with a ball point, which may be preferred by users for handwriting endeavors. Similarly, nib 107b is depicted with a chisel tip, which may be preferred by users for marking or highlighting. Nib 107c is depicted with a brush tip, which may be preferred for digital painting. Thus, users are able to advantageously switch between multiple tips 104 depending on the particular intended usage of the touch input device 101.

As depicted in FIG. 1, touch input device 101 may also include a circuit 109 and a wireless transceiver 111. As depicted in FIG. 1, both the circuit 109 and the wireless transmitter 111 can be disposed within the interior of the body 103. As depicted in FIG. 1, the wireless receiver may be communicatively coupled to the circuit 109 via a bus. In one or more embodiments, the circuit 109 may be implemented as, for example, a printed circuit board (PCB) with one or more of a processor and memory device collectively configured to determine various parameters of a touch input and/or of the touch input device. In addition, the circuit 109 may include one or more sensors configured to determine usage data, such as a pressure sensor operable to detect a pressure applied by a user to the touch input device 101, a gyroscope to determine an orientation of the touch input device 101, and an accelerometer to determine movement of the touch input device 101. Other parameters of the touch input and/or of the touch input device that can be detected by the circuit 109 include data corresponding to the tip type or tip shape to determine the specific tip currently attached to the touch input device 101 (e.g., nib 107a, nib 107b, nib 107c).

In still further embodiments, touch input device 101 may also include one or more user-operated controls 113 (e.g., push buttons) which can be activated (via, for example, user-applied pressure) by the user. The user-operated controls 113 may be implemented according to a variety of implementations that include, for example, any mechanism which can be toggled, and/or selected between. The user-operated controls may be pre-programmed and/or programmable to perform one or more operations (e.g., generate one or more signals as user-input) when actuated. In still further embodiments, touch input device 101 may also include one or more end units 115 disposed on an opposite end of the body 103 from the tip 104. The end unit 115 may also be implemented from an electrically conductive material and be used to generate a specific touch input when applied to a touch screen device. For example, the end unit 115 may be implemented as a dedicated erasing unit, which, when the touch input device is positioned so that the end unit 115 is rendered upside-down (as determined by a gyroscope, for example) and applied to a touch screen, previously detected user input displayed in a touch screen display can be removed that corresponds to the positions in the touch screen at which touch input from the end unit 115 is detected.

In still further embodiments, characteristics of the touch input device 101 and/or parameters of a usage of the touch input device 101 can also be determined by circuitry and/or components disposed in the touch input device 101. For example, data corresponding to a relative current velocity, orientation, angle, etc. of the touch input device 101 may be calculated to accurately determine and/or infer the intended usage of the touch input device by generating and detecting signal data or referencing pre-determined configuration data in components in the touch input device and sending that data as wireless signal data from the wireless transceiver 111 to one or more corresponding wireless transceivers in a paired touch screen. The circuits and/or sensor components in the touch input device may include, but are not limited to, components such as an accelerometer, a compass, a tip detection mechanism, or gyroscope. The data generated in these sensors or circuits may correlate to usage information, such as the direction of travel of the touch input device, how the device is held or being used, writing tendencies or characteristics of the user. This information can be used to supplement, supersede, or even contradict information calculated by a touch controller based on the electric signals generated in the touch sensors of the touch screen.

For example, position detection using touch sensors still experience a latency between when the touch gesture is performed, when the touch gesture is detected, and how the touch gesture and position is calculated. Sharp movements therefore may not be detected as quickly or accurately using a touch controller alone. The supplementary data however may be detected and transmitted to the touch controller pre-emptively, therefore improving responsiveness. In one or more embodiments, any and/or all of the parameter or usage data described above may be accumulated by the circuit 109 (via, for example, the aforementioned sensors) or determined by sensor controllers executed by a processor and stored in caches and/or a memory device of the circuit 109. In still further embodiments, the accumulated data may be communicated to a wireless transceiver 111 and forwarded to a wireless receiver in a corresponding touch screen device (not shown) to supplement touch input data generated by a touch screen controller in response to contact between the touch input device and the touch screen itself.

In one or more embodiments, the information received from the touch input device is used as a secondary source of information to confirm or supplement the (primary) data received by the touch controller from the touch screen. By supplementing the touch input data with parameter data generated by circuits, sensors, or other components in the touch input device 101, additional types of input or usage data can be calculated, and/or may be calculated with greater accuracy over calculations performed by the touch screen and controller alone. In addition, by generating the parameter data in the touch input device 101 itself, some of the touch input data may be eliminated from being generated in the touch screen, thereby freeing the touch screen controller to process other input data more quickly. For example, by identifying and communicating the shape of a nib (e.g., 107a, 107b, 107c), the touch screen may no longer have to (continuously) determine the shape of the touch input device or calculate whether an input received from the touch screen corresponds to the tip of the touch input device or is input from another object (e.g., in multi-touch detection applications). The touch controller of the touch screen device is also able to optimize touch detection and input calculation specifically for the detected tip or nib—by, for example, entering into a dedicated mode specifically optimized for the detected tip or nib. Likewise, by supplementing position and location data with wireless triangulation, the position and location of the touch input device 101 in a surface of a touch screen device can be verified with greater speed and/or accuracy.

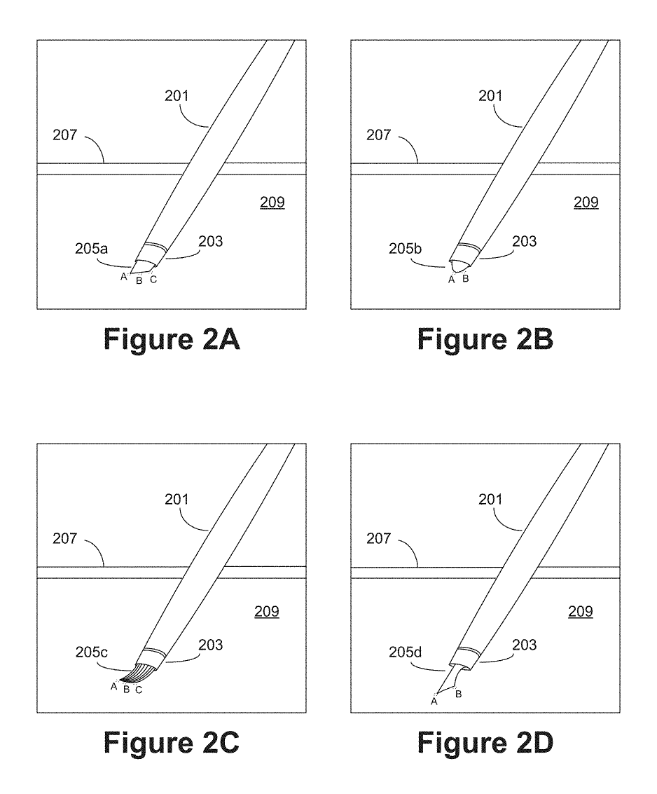

FIGS. 2A-2D depict exemplary touch input detection generated by a touch input device 201 in a touch screen device 207. FIG. 2A depicts an exemplary touch input detection in a touch screen device 207 generated by a touch input device 201 with a first input interface, in accordance with various embodiments of the present invention. FIG. 2B depicts an exemplary touch input detection in the touch screen device 207 generated by the touch input device 201 with a second input interface, in accordance with various embodiments of the present invention. FIG. 2C depicts an exemplary touch input detection in the touch screen device 207 generated by a touch input device 201 with a third input interface, in accordance with various embodiments of the present invention. FIG. 2D depicts an exemplary touch input detection in a touch screen device 207 generated by a touch input device 201 with a fourth input interface in accordance with various embodiments of the present invention.

As depicted in FIGS. 2A-2D, input interfaces of the touch input device 201 may include a tip base 203 with a shaped nib. For example, FIG. 2A depicts a tip base 203 with a chisel-tipped nib 205a), whereas FIGS. 2B, 2C, and 2D depict, respectively, exemplary tip bases 203 with a ball-point nib 205b, a brush-tip 205c, and a broad-tipped nib 205d. The tip base 203 may be statically coupled to the touch input device 201 or interchangeable with other compatible tip bases, according to various embodiments. Alternatively, the tips/nibs themselves (e.g., 205a, 205b, 205c, and 205d) may be interchangeable between tip bases 203. In one or more embodiments, data corresponding to the size and shape of the current nib or tip coupled to the end of the touch input device 201 may be stored in a memory disposed in the touch input device 201 and/or communicated to a touch screen controller of a touch screen device to assist in touch input detection.

As depicted in FIGS. 2A-2D, touch screen device 207 may include a touch screen 209, implemented as a surface (such as glass) above an arrangement of capacitive sensors. In one or more embodiments, the arrangement comprises a layer of projective capacitive sensors in a grid, which, when a voltage is supplied across the layer, forms a uniform electrostatic field. When an electrically conductive object, such as a human finger or the touch input devices described above, approaches or contacts the surface, the electrostatic field is distorted, and the charge accumulated in the capacitive sensors is drained (using the object or object-user as a ground) proportionally with respect to the proximity of the input, such that capacitive sensors closest to a point of contact experience the greatest change. The change in voltage across the sensors is detected by a touch controller (typically by measuring the frequency of an oscillator or signal corresponding to the sensor) and a touch input is registered.

In one or more embodiments, the rate at which an electrical charge is drained may also be measured and used to determine the particular tip shape. For example, due to the varying shapes and contact points of the nibs and tips (205a, 205b, 205c, 205d), touch input can be registered at multiple sensors from a single contact. For example, a chisel-tipped nib (e.g., 205a) may register touch input at multiple contact points (e.g., A, B, C), thereby having a proportionally greater impact on the capacitive sensors most proximate to those contact points. However, due to the angle of the chisel-tipped nib 205a, the end of the nib with the further projection (corresponding to contact point A) may begin draining the charge at an earlier moment in time—however briefly—than the end of the nib corresponding to the last contact point (C), or drain at a faster rate (e.g., a discharge rate). It is appreciated that the number, position, and discharge rate of the contact points may vary for each tip or nib. For example, ball-point nib 205b and broad-tipped nib 205d are each depicted in FIGS. 2B and 2D (respectively) with two contact points (A, B), however, the ball-point nib 205b may have contact points with greater proximity to each other relative to a broad tipped nib 205d. On the other hand, brush 205c is depicted in FIG. 2C with three contact points (A, B, C), but where ball-point nib 205b and broad-tipped nib 205d may (or may not) discharge at relatively similar rates at each of their contact points, brush 205c may discharge at a greater rate at the contact point closest to its center of mass (e.g., contact point b), and may discharge at decreasingly lower rates at contact points farthest away from the center of mass.

In still further embodiments, a contact point is registered only once the drop in voltage and/or rate of discharge is determined to be above a pre-determined threshold for a period of time. In addition, the orientation and/or grip of the user may also factor into which contact points are registered and in what sequences. Thus, the position of a touch input device 201 may be determined by detecting where in the capacitive sensor grid a drop in voltage and accumulated charge is experienced, and the specific shape of the touch input device 201 may be determined by measuring the discharge rate at each point of contact of the touch input device 201. In one or more embodiments, the discharge rate and number of possible points of contact corresponding to each tip or nib may be pre-stored (e.g., in a table) and determined and/or corroborated by referencing the pre-stored data.

As described above, embodiments of the present inventive concepts include tips and nibs of various sizes and shapes, some of which are capable of generating contact points with areas significantly smaller or larger than contact points generated by traditionally used objects (e.g., fingers, styluses). Some embodiments may include, for example, fine-tipped nibs capable of generating contact points with areas as small as 1 millimeter in diameter or less. According to such embodiments, the pitch (e.g., the areas enclosed by capacitive sensor lines forming the touch screen grid) may be reduced to increase sensitivity to smaller contact points. The pitch may be reduced by, for example, increasing the density and number of sensor lines in the grid. Alternately, a higher voltage may be supplied to increase the sensitivity of the sensors to detect finer contact points. According to these embodiments, the touch screen devices described herein may be equipped with a higher density of capacitive sensing features, or operated using a higher supplied voltage to provide a touch screen capable of detecting contact points at least as small as 1 millimeter in diameter.

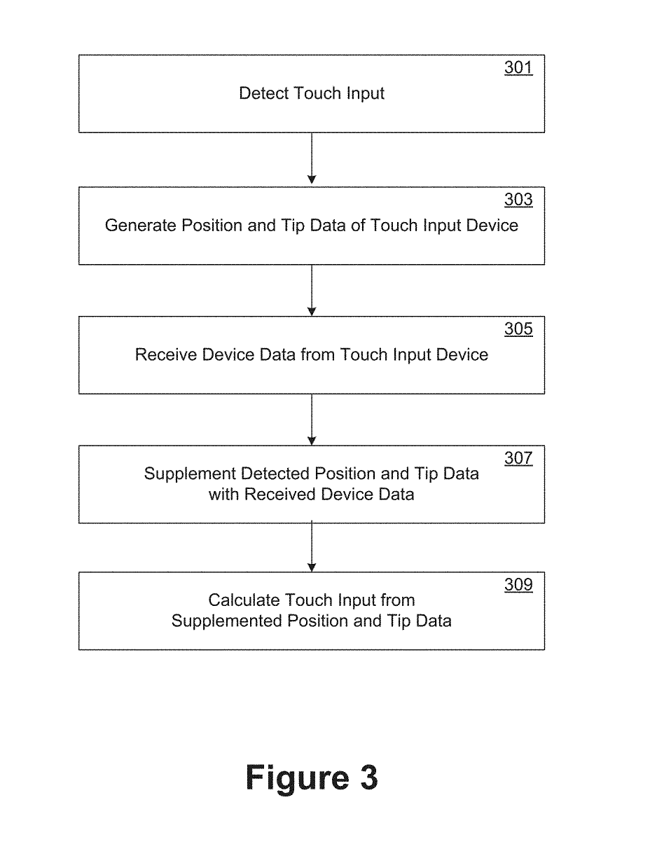

FIG. 3 depicts a flowchart of an exemplary process 300 for calculating touch input in a touch screen device, in accordance with various embodiments of the present invention. Steps 301-309 describe exemplary steps of the flowchart 300 in accordance with the various embodiments herein described. According to some embodiments, some or all of the steps 301-307 may be performed by one or more touch controllers executed by one or more processors (specifically, in a touch screen device).

At step 301, a touch input is detected in a touch screen device. In one or more embodiments, the touch input corresponds to a touch input device, such as a stylus. Touch input may be detected in a touch screen of the touch screen device by detecting (via measurement) a drop in voltage and/or accumulated charge in one or more capacitive sensors comprised in the touch screen. In one or more embodiments, the capacitive sensors comprise projective capacitive sensors arranged in one or more layers as a two dimensional array (grid), configured to drain an accumulated charge upon contact with an electrically conductive object (such as a stylus or other touch input device).

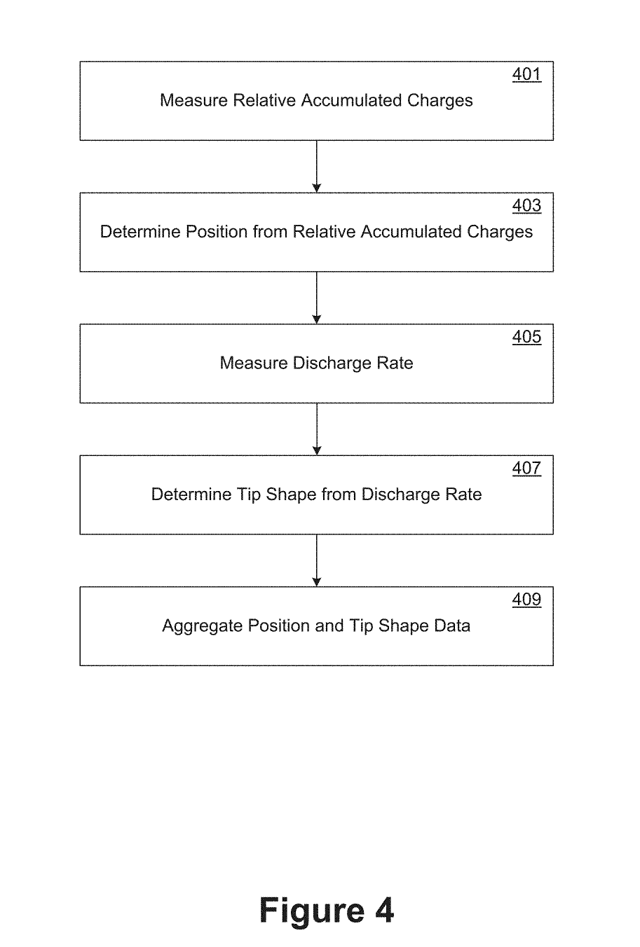

At step 303, the position and tip parameter/characteristic data of the touch input is generated. Generation of the position data is described in greater detail below, with respect to FIG. 4. At step 305, input device parameter data is received from the touch input device whose touch input was detected at step 301. Input device parameter data may include, for example, identification data corresponding to the user input device (e.g., model, version, serial number), data corresponding to the hardware in the device (e.g., processor, memory, wireless communication capabilities) or the software executing in the device (firmware version, application version). Device parameter data may also include data determined in the input device from one or more sensors. For example, orientation data may be generated by a gyroscope in the input device and included in the device parameter data. Likewise, velocity data may be determined by accelerometers in the input device and included in the device parameter data. The input device parameter data may also include position/location data generated in the input device (e.g., via wireless triangulation). In one or more embodiments, the input device parameter data received in step 305 also includes data (e.g., tip size and shape, number of contact points, etc.) corresponding to the tip currently equipped by the input device data. In still further embodiments, the input device data may also include data corresponding to a user actuation of user operable controls.

In one or more embodiments, the input device parameter data may be received wirelessly, through, for example, a radio-frequency communication such as WiFi, Bluetooth (BT), or near-field communication (NFC) from a paired device equipped with wireless communication capability. Alternately, the input device parameter data may be received through a physical wired connection between the input device and the touch screen device. According to one or more embodiments, the parameter data may be received continuously while the touch input device is used and/or a touch input is detected in the touch screen device.

At step 307 of FIG. 3, the position and tip data generated at step 303 is supplemented with the device parameter data received in step 305 and the aggregated input data is provided to the touch controller of the touch screen device. In one or more embodiments, the aggregated input data may be used to update the position and tip data generated at step 303 in the touch controller. Alternately, or in addition, the aggregated input data may be stored in a memory or the cache of the processor executing the touch controller. The touch input is thereafter calculated at step 309 from the supplied data to register a more accurate and precise touch input.

FIG. 4 depicts a flowchart of an exemplary process 400 for determining a position and tip shape of a touch input device in a touch screen, in accordance with various embodiments of the present invention. Steps 401-409 describe exemplary steps of the flowchart 400 in accordance with the various embodiments herein described. According to some embodiments, some or all of the steps 401-407 may be performed during the performance of step 303 by one or more touch controllers executed by one or more processors (specifically, in a touch screen device).

Steps 401 and 403 correspond to determining the position in the touch screen of a touch input device generating touch input by measuring drops in voltage (accumulated charge). At step 401, the relative accumulated charges in the capacitive sensors of the touch screen are measured. The accumulated charges may be measured by a touch controller in the touch screen device based on the electrical charge in the one or more capacitive sensors. When a drop voltage beyond a threshold is detected, the amount of the drop(s) and/or the remaining charge(s) are measured to determine the sensors in the sensor grid that have experienced the greatest drops. The sensors with the greatest drops typically correspond to the sensors most proximate to contact points of the touch input device, and the position in the touch screen is determined at step 403 by identifying which sensors correspond to the contact point(s) of the touch input device.

Steps 405 and 407 correspond to determining the size and shape of an interface (e.g., tip) of a touch input device by measuring the discharge rate of charges resulting from the touch input. At step 405, the drainage rate of the affected sensors in step 401 is measured, and the size and shape is determined at step 407 based on the measured rates of drain. In one or more embodiments, the drainage rates of affected sensors correspond to the proximity of those sensors to one or more contact points. Multiple affected sensors each draining at sufficient rates to correspond to proximity to a contact point over a distributed area would thus imply that the touch input device either has many contact points at multiple corners, or a contact surface that covers the distributed area. Determining between the two may be performed by measuring the drainage rate of sensors within the perimeter established by the distributed area, where relatively constant drainage rates would imply a larger contact surface, and inconsistent drainage rates imply multiple, interspersed contact points. Thus, determining the total area of the affected sensors in addition to the sensors experiencing drainage at the highest rates may be used to approximate the shape and size of the input object. In one or more embodiments, detection of the tip size and/or shape causes the touch controller to enter a different mode optimized specifically for the detected tip size and/or shape. For example, for touch input devices equipped with tips with single, smaller contact surfaces (e.g., points), touch detection may be optimized for precision with the threshold for detecting a contact point adjusted to eliminate mis-detections or noise. Alternately, the particular touch controller mode may be optimized to more efficiently distinguish between tips with a single large contact surface or tips with multiple contact surfaces distributed over an entire area.

At step 409, the position data determined at step 403 and the size and shape data determined at step 407 is combined and transmitted to a touch controller in a touch screen device paired with the touch input device. In one or more embodiments, the tip size and shape may be verified by the touch screen device by referencing a pre-stored data structure (e.g., table) of known touch input interfaces (e.g., touch input device tips) in one or more of the touch screen device and the touch input device.

### Exemplary Computing Device

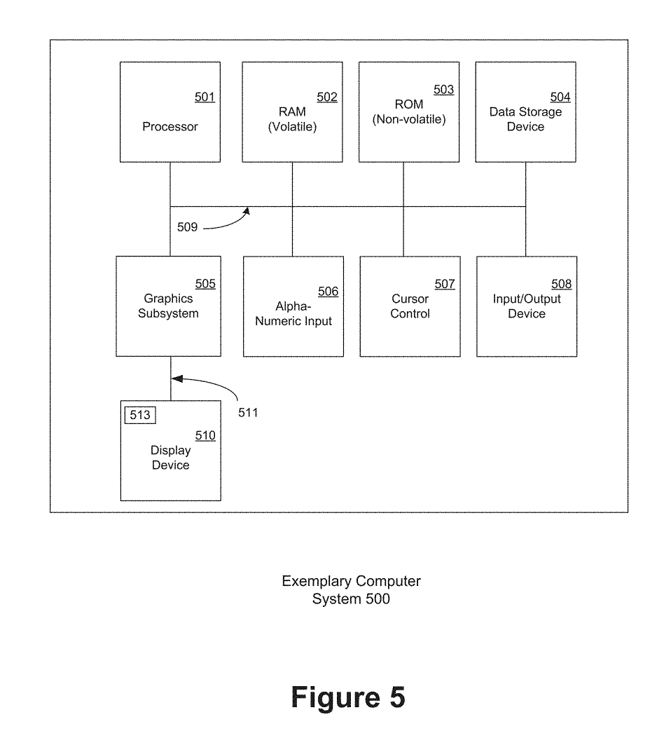

As presented in FIG. 5, an exemplary system upon which embodiments of the present invention may be implemented includes a touch screen device, such as touch screen computing system 500. In its most basic configuration, touch screen computing system 500 typically includes at least one processing unit 501 and memory, and an address/data bus 509 (or other interface) for communicating information. Depending on the exact configuration and type of computing system environment, memory may be volatile (such as RAM 502), nonvolatile (such as ROM 503, flash memory, etc.) or some combination of the two.

Touch screen computing system 500 may also comprise an optional graphics subsystem 505 for presenting information to the user, e.g., by displaying information on an attached display device 510. According to embodiments of the present claimed invention, the display device 510 may include one or more light emitting elements, such as a liquid crystal display (LCD) or light emitting diodes (LEDs), over which a touch screen 513 comprising a conductive surface (like glass) and a grid of capacitive sensors operated and managed by a touch controller is disposed. In one or more embodiments, the graphics subsystem 505 may be coupled directly to the display device 510 through a graphics bus 511. A graphical user interface executing in the touch screen computing system 500 may be generated in the graphics subsystem 505, for example, and displayed to the user in the display device 510. In one embodiment, the processes 300 and 400 may be performed, in whole or in part, by graphics subsystem 505 in conjunction with the processor 501 and memory 502, with any resulting output displayed in attached display device 510.

Additionally, touch screen computing system 500 may also have additional features/functionality. For example, touch screen computing system 500 may also include additional storage (removable and/or non-removable) including, but not limited to, magnetic or optical disks or tape. Such additional storage is illustrated in FIG. 5 by data storage device 504. Computer storage media includes volatile and nonvolatile, removable and non-removable media implemented in any method or technology for storage of information such as computer readable instructions, data structures, program modules or other data. RAM 502, ROM 503, and data storage device 504 are all examples of computer storage media.

Touch screen computing system 500 also comprises an optional alphanumeric input device 506, an optional cursor control or directing device 507, and one or more signal communication interfaces (input/output devices, e.g., a network interface card) 508. In one or more embodiments, at least one of the alphanumeric input device 506 and directing device 507 may be implemented as a virtual alphanumeric input device or directing device through the combination of the graphical user interface rendered by the graphics subsystem 505 and the touch screen device 513. Optional alphanumeric input device 506 can communicate information and command selections to central processor 501. Optional cursor control or directing device 507 is coupled to bus 509 for communicating user input information and command selections to central processor 501. Signal communication interface (input/output device) 508, also coupled to bus 509, can be a serial port. Communication interface 509 may also include wireless communication mechanisms. Using communication interface 509, touch screen computing system 500 can be communicatively coupled to other computer systems over a communication network such as the Internet or an intranet (e.g., a local area network), or can receive data (e.g., a digital television signal).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In the foregoing specification, embodiments have been described with reference to numerous specific details that may vary from implementation to implementation. Thus, the sole and exclusive indicator of what is the invention, and is intended by the applicant to be the invention, is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A hybrid stylus system comprising:
a user input touch device comprising a circuit configured to wirelessly communicate data comprising a plurality of characteristics corresponding to the user input touch device; and
a computing device comprising:
a wireless receiver configured to receive the data from the user input touch device;
an input surface implemented as a plurality of capacitive sensors, each capacitive sensor of the plurality of capacitive sensors being configured to discharge an accumulated charge when the capacitive sensor corresponds to a contact point of the user input touch device, and to generate a signal based on the discharge;
a processor configured to implement a touch controller, the touch controller being configured to detect a position of the user input touch device and a shape of a tip of the user input touch device based on at least one contact point between the user input touch device and the input surface.

2. The system according to claim 1, wherein the touch controller is configured to detect a position of the user input touch device by measuring a relative charge of the plurality of capacitive sensors to determine the capacitive sensors at a plurality of contact points corresponding to the tip of the user input touch device.

3. The system according to claim 2, wherein a capacitive sensor of the plurality of capacitive sensors is configured to discharge the accumulated charge using physical contact with a user as a ground.

4. The system according to claim 1, wherein the touch controller is configured to determine the shape of the tip of the user input touch device by measuring a discharge rate of the accumulated charges of the plurality of capacitive sensors.

5. The system according to claim 4, wherein the discharge rate corresponds to at least one of: a number of contact points of the user input touch device, and a total area comprised by the contact points of the user input touch device.

6. The system according to claim 1, wherein the circuit comprised in the user input touch is further configured to supplement the signal generated by a capacitive sensor charge when the capacitive sensor corresponds to a contact point of the user input touch device.

7. The system according to claim 1, wherein the user input touch device comprises at least one button, further wherein the circuit comprised in the user input touch is further configured to wirelessly communicate user actuation of the at least on button to the computing device.

8. The system according to claim 1, wherein the plurality of characteristics corresponding to the user input touch device comprises at least one of:
a shape of the tip of the user input touch device;
a position of the user input touch device during a usage of the user input touch device;
an angle of the user input touch device during a usage of the user input touch device;
an orientation of the user input touch device during a usage of the user input touch device;
a speed of the user input touch device during a usage of the user input touch device; and
a direction of the user input touch device during a usage of the user input touch device.

9. The system according to claim 1, wherein the input touch device comprises a pressure sensor and further wherein the plurality of characteristics corresponding to the user input touch device corresponds to a pressure exerted by a user on the input surface via the user input touch device.

10. The system according to claim 1, wherein the circuit comprised in the user input touch device is configured to wirelessly communicate data using a radio frequency (RF) communication connection.

11. The system according to claim 10, wherein the RF communication connection comprises at least one of:
a Wi-Fi connection;
a BlueTooth (BT) connection; and
a near-field communication (NFC) connection.

12. The system according to claim 1, wherein the circuit comprised in the user input touch device is further configured to wirelessly communicate the data at a frequency higher than a frequency of capacity sensing the plurality of capacitors in the computing device is configured to perform.

13. The system according to claim 1, wherein the tip of the user input touch device comprises at least one of:
a brush head;
a chisel point;
a ball point;
a fine-tip;
a rounded tip; and
a tip designated for erasing.

14. A method for detecting motion of a user input touch device in a touch screen, the method comprising:
detecting a touch input in a touch screen device comprising a plurality of capacitive sensors;
generating, in a touch controller executed by a processor of the touch screen device, data corresponding to a position and tip shape of a user input touch device;
receiving, from the user input touch device over a wireless communication connection, data corresponding to a plurality of characteristics of the user input touch device;
supplementing the generated data with the received data corresponding to a plurality of characteristics of the user input touch device; and
calculating user input based on the supplemented data.

15. The method according to claim 14, wherein the generating the data corresponding to a position and tip shape of a user input touch device comprises:
measuring relative accumulated charges in a plurality of capacitive sensors;
determining at least one contact point corresponding to the position of the user input touch device based on the relative accumulated charges;
measuring a discharge rate at the at least one contact point;
determining a tip shape corresponding to the user input touch device based on the discharge rate; and
combining the data based on the determined position and tip shape corresponding to the user input touch device.

16. The method according to claim 14, wherein the user input touch device comprises at least one button, further wherein the receiving the data corresponding to a plurality of characteristics comprises receiving data corresponding to a user actuation of the at least on button to the computing device.

17. The method according to claim 14, wherein the receiving data corresponding to a plurality of characteristics corresponding to the user input touch device comprises receiving data corresponding to at least one of:
a shape of the tip of the user input touch device;
a position of the user input touch device as secured by a user during a usage of the user input touch device;
an angle of the user input touch device as secured by a user during a usage of the user input touch device;
an orientation of the user input touch device as secured by a user during a usage of the user input touch device;
a speed of the user input touch device during a usage of the user input touch device; and
a direction of the user input touch device during a usage of the user input touch device.

18. The method according to claim 14, wherein the input touch device comprises a pressure sensor and further wherein the receiving the data corresponding to a plurality of characteristics comprises receiving data corresponding to a pressure exerted by a user on the input surface via the user input touch device.

19. A computer readable medium comprising a plurality of programmed instructions, which when executed by a processor of a computing device, is operable to implement motion detection of a user input touch device in a touch screen, the programmed instructions comprising:
instructions to detect a touch input in a touch screen device comprising a plurality of capacitive sensors;
instructions to generate, in a touch controller executed by a processor of the touch screen device, a signal comprising data corresponding to a position and tip shape of a user input touch device;
instructions to receive, from the user input touch device over a wireless communication connection, data corresponding to a plurality of characteristics of the user input touch device;
instructions to supplement the generated data with the received data corresponding to a plurality of characteristics of the user input touch device; and
instructions to calculate user input based on the supplemented data.

20. The computer readable medium according to claim 19, wherein the instructions to generate the signal comprising data corresponding to the position and tip shape of a user input touch device comprises:
instructions to measure relative accumulated charges in a plurality of capacitive sensors;
instructions to determine at least one contact point corresponding to the position of the user input touch device based on the relative accumulated charges;
instructions to measure a discharge rate at the at least one contact point;
instructions to determine a tip shape corresponding to the user input touch device based on the discharge rate; and
instructions to generate the signal based on the determined position and tip shape corresponding to the user input touch device.

21. The computer readable medium according to claim 19, wherein the user input touch device comprises at least one button, further wherein the instructions to receive the data corresponding to a plurality of characteristics comprises instructions to receive data corresponding to a user actuation of the at least on button to the computing device.

22. The computer readable medium according to claim 19, wherein the instructions to receive data corresponding to a plurality of characteristics corresponding to the user input touch device comprises instructions to receive data corresponding to at least one of:
a shape of the tip of the user input touch device;
a position of the user input touch device as secured by a user during a usage of the user input touch device;
an angle of the user input touch device as secured by a user during a usage of the user input touch device;
an orientation of the user input touch device as secured by a user during a usage of the user input touch device;
a speed of the user input touch device during a usage of the user input touch device; and
a direction of the user input touch device during a usage of the user input touch device.

23. The computer readable medium according to claim 19, wherein the input touch device comprises a pressure sensor, further wherein the instructions to receive the data corresponding to a plurality of characteristics comprises instructions to receive data corresponding to a pressure exerted by a user on the input surface via the user input touch device.
